(19) United States
(12) Patent Application Publication
(10) Pub. No.: US 2024/0128703 A1
(43) Pub. Date: Apr. 18, 2024

(54) LASER AMPLIFICATION MEDIUM COOLING DEVICE

(71) Applicant: Lasernics Co., Ltd., Daejeon (KR)

(72) Inventors: Cheen Su AN, Daejeon (KR); Yunseok KIM, Cheongju-si (KR); Se Hoon PARK, Gwangju (KR)

(73) Assignee: Lasernics Co., Ltd., Daejeon (KR)

(21) Appl. No.: 18/051,495

(22) Filed: Oct. 31, 2022

(30) Foreign Application Priority Data
Oct. 13, 2022 (KR) 10-2022-0131303

(51) Int. Cl. H01S 3/04; H01S 3/042

(52) U.S. Cl. CPC H01S 3/0407; H01S 3/042

(57) ABSTRACT

Provided is a laser amplification medium cooling device capable of effectively dissipating heat generated in a laser amplification medium. The laser amplification medium cooling device includes a cooling module configured to cool an amplification medium for amplifying a laser, wherein the cooling module includes a cooling chamber having a flow path accommodating the amplification medium formed therein and a refrigerant flowing along the flow path to cool the amplification medium, wherein the refrigerant is a metallic fluid that maintains a liquid state at room temperature.

### CROSS-REFERENCE TO RELATED APPLICATION

This application claims benefit of priority to Korean Patent Application No. 10-2022-0131303, filed on Oct. 13, 2022 in the Korean Intellectual Property Office, the disclosure of which is incorporated herein by reference in its entirety.

### BACKGROUND

### 1. Field

The present disclosure relates to a laser amplification medium cooling device.

### 2. Description of Related Art

As machining and measurement using lasers have advanced, demand for higher power lasers has increased.

In order to enhance the output of lasers, when a stabilized laser beam is incident to an amplification medium and a diode laser beam is applied as a pump beam, the laser is amplified such that energy of an output laser increases.

Here, the excess energy after the pump beam is transferred as the laser output is converted into thermal energy, which is mainly diffused to the surroundings through conduction from the amplification medium.

At this time, if proper heat dissipation and cooling are not accompanied, a local high temperature portion may be formed in the amplification medium and deterioration may occur, so the performance of the amplification medium may be degraded or the amplification medium may be damaged by thermal shock.

In general, when the laser output is low, heat conducted from the amplification medium to a heat dissipation surface is dissipated using a heat sink or a cooling fan, but as the output of the laser increases so that thermal energy generated in the amplification medium is above a certain level, there is a limit to heat dissipation by simply conducting heat, and thus, water-cooled cooling is performed to dissipate heat by circulating a liquid cooling medium.

Water-cooled cooling has the advantages of dissipating relatively a lot of heat with a small flow rate using water with a large specific heat and maintaining a small change in the temperature of the medium when the same thermal energy is transported.

However, water-cooled cooling using water has a problem in that galvanic corrosion occurs or rust is deposited depending on a material of a cooling surface, which tends to cause problems in pipe circulation.

Meanwhile, oil-cooled cooling using oil instead of water may not cause oxidative corrosion on metal materials, but since oil has a small specific heat and high viscosity compared to water, more energy is required for the pump to move oil and pressure at an outlet of the pump increases to cause oil leakage.

In addition, rubber-based sealants exposed to oil are chemically vulnerable to oil and oil is easily oxidized to cause other problems such as increased viscosity or constriction of a flow path.

In addition, in the cooling method using water or oil as a medium, pressure wave is generated in a pipe due to the inertia of a flowing liquid, which directly affects stability of an output beam.

That is, when a flow rate increases according to the amount of heat dissipation, a flow pressure of the liquid applied to the amplification medium through the flow path also increases, thereby damaging the amplification medium or affecting the amplification medium, so that stable output cannot be achieved.

### RELATED ART DOCUMENT

(Patent Document 1) Korean Patent Registration No. 10-1750821 10

### SUMMARY

An aspect of the present disclosure may provide a laser amplification medium cooling device capable of effectively dissipating heat generated in a laser amplification medium.

An aspect of the present disclosure may also provide a laser amplification medium cooling device capable of supplementing the shortcomings of a water-cooled cooling method and an oil-cooled cooling method and maximizing heat dissipation performance.

An aspect of the present disclosure may also provide a laser amplification medium cooling device capable of maintaining a constant temperature of an amplification medium by supplementing the shortcomings of the water-cooled cooling method and the oil-cooled cooling method.

The problems of the present disclosure are not limited to the problems mentioned above, and other problems not mentioned will be clearly understood by those skilled in the art from the following description.

According to an aspect of the present disclosure, a laser amplification medium cooling device includes: a cooling module configured to cool an amplification medium for amplifying a laser, wherein the cooling module includes: a cooling chamber having a flow path accommodating the amplification medium formed therein; and a refrigerant flowing along the flow path to cool the amplification medium, wherein the refrigerant is a metallic fluid that maintains a liquid state at room temperature.

The refrigerant may include at least one of gallium (Ga), aluminum (Al), copper (Cu), bismuth (Bi), tin (Sn), and indium (In).

The flow path may be configured so that the refrigerant flows in a spiral direction around the amplification medium.

The flow path may include: a first flow path accommodating the amplification medium and having a cylindrical structure so that the refrigerant introduced therein flows in a spiral direction along a circumference of the amplification medium; a second flow path communicating with a portion of the first flow path, disposed to cross a central axis of the first flow path, and introducing the refrigerant into the first flow path; and a third flow path communicating with another portion of the first flow path, disposed to cross the central axis of the first flow path, and discharging the refrigerant from the first flow path.

The cooling chamber may include: a chamber housing having the flow path formed therein and having one side open in an axial direction and the other side provided with a first chamber hole communicating with the first flow path and having a diameter smaller than that of the first flow path; and a chamber cover coupled to the open one side of the chamber housing and having a second chamber hole communicating with the first flow path therein and having the same diameter as that of the first chamber hole.

The cooling module may further include: a first window accommodated in the first flow path, contacting one end portion of the amplification medium in the axial direction of the amplification medium, and exposed to the outside through the first chamber hole; a second window accommodated in the first flow path, contacting the other end portion of the amplification medium in the axial direction of the amplification medium, and exposed to the outside through the second chamber hole; a first hermetic ring accommodated in the first flow path and press-fitted between the first window and the first chamber hole to seal a space between the first window and the first chamber hole; and a second hermetic ring accommodated in the first flow path and press-fitted between the second window and the second chamber hole to seal a space between the second window and the second chamber hole.

The laser amplification medium cooling device may further include; a heat dissipation module coupled to the cooling module and configured to cool the refrigerant, while circulating the refrigerant.

The heat dissipation module includes: a circulation block assembly coupled to the cooling module and communicating with the cooling module, configured to circulate the refrigerant to introduce and discharge the refrigerant to and from the cooling module; a heat dissipation block contacting the circulation block assembly and configured to heat-exchange with the refrigerant flowing in the circulation block assembly to dissipate heat of the refrigerant to the outside; and a plurality of fastening members coupling the circulation block assembly and the heat dissipation block.

The circulation block assembly may include: a first block configured to cause the refrigerant accommodated therein to flow using magnetic force; a second block disposed between the cooling module and the first block and connecting the cooling module and the first block to allow the refrigerant to circulate; and a third block disposed between the first block and the heat dissipation block to communicate with the first block and guiding the refrigerant so that the refrigerant introduced from the first block flows along an outer surface of the heat dissipation block and then is introduced into the first block.

The first block may include: a block body communicating with the cooling chamber and configured to allow the refrigerant to flow therein; and a pump unit configured to cause the refrigerant accommodated in the block body to flow by a spatial change of magnetic force.

The pump unit may be disposed in the center of the block body and configured to cause the refrigerant accommodated in the block body to flow by rotation of magnetic force.

The block body may include: an accommodating hole in which the pump unit is accommodated; a wiring hole connecting the accommodating hole and an external space to form wiring of the pump unit; an arcuate first buffer channel disposed inside the block body to surround a portion of the accommodating hole and having a portion extending to an upper portion of the block body to communicate with the second flow path through the second block and the other portion extending to a lower portion of the block body to communicate with the third block; an arcuate second buffer channel disposed inside the block body to surround another portion of the accommodating hole and having a portion extending to an upper portion of the block body to communicate with the third flow path through the second block and the other portion extending to a lower portion of the block body to communicate with the third block; and a plurality of first through-holes through which the plurality of fastening members pass.

The second block may include: a first communication hole connecting the first buffer channel and the second flow path; a second communication hole connecting the second buffer channel and the third flow path; and a plurality of second through-holes communicating with the plurality of first through-holes through which the plurality of fastening members pass.

The first communication hole may include: a first communication portion communicating with a portion of the first buffer channel and disposed coaxially with a portion of the first buffer channel; and a first direction changing portion connecting the first communication portion and the second flow path and changing a flow direction of the refrigerant flowing from the first communication portion to the second flow path to attenuate pressure wave of the refrigerant, and the second communication hole may include: a second communication portion communicating with a portion of the second buffer channel and disposed coaxially with a portion of the second buffer channel; and a second direction changing portion connecting the second communication portion and the third flow path and changing a flow direction of the refrigerant flowing from the third flow path to the second communication portion to attenuate pressure wave of the refrigerant.

The third block may include: a third buffer channel formed on one surface of the third block in contact with the heat dissipation block and guiding a flow of the refrigerant so that the refrigerant introduced through the second buffer channel is branched plurally to flow along an outer surface of the heat dissipation block; a discharge hole connecting the third buffer channel and another portion of the first buffer channel to discharge the refrigerant flowing from the third buffer channel to the first buffer channel; an inlet hole connecting the third buffer channel and another portion of the second buffer channel to introduce the refrigerant discharged from the second buffer channel into the third buffer channel; and a plurality of third through-holes communicating with the plurality of first through-holes through which the plurality of fastening members pass.

The third buffer channel may include: a first channel portion in which the refrigerant introduced through the inlet hole is branched plurally to flow, while being diffused along an outer surface of the heat dissipation block; a second channel portion in which the refrigerant passing through the first channel portion is branched plurally to flow along the outer surface of the heat dissipation block and then integrated to be discharged to the outlet hole; and a third channel portion connecting the first channel portion and the second channel portion, in which the refrigerant branched to flow from the first channel portion is integrated and introduced into the second channel portion.

The heat dissipation block may include: a plate portion in contact with the third block and exchanging heat with the refrigerant flowing in the third buffer channel; a plurality of heat dissipation fins disposed along one surface of the plate portion and dissipating heat conducted through the plate portion to the outside; and a plurality of fastening holes formed in the plate portion to communicate with the plurality of third through-holes and screw-coupled to the plurality of fastening members protruding to the outside through the plurality of third through-holes.

According to an embodiment of the present disclosure, since a liquid metallic fluid having a higher thermal conductivity than water or oil is used as a refrigerant, heat dissipation performance is maximized to quickly remove heat generated in an amplification medium, and accordingly, damage to the amplification medium due to heat may be prevented, thereby maintaining stable laser output performance.

In addition, since the refrigerant is formed of a material having a lower viscosity coefficient than oil, the same flow may be maintained with less pump pressure compared to oil, and accordingly, a phenomenon in which pressure is increased in a specific area and the refrigerant is leaked to the outside may be prevented.

In addition, since the refrigerant is formed of a metallic material in a liquid state, corrosion of a contact object or blockage of a flow path due to oxidation may be prevented by appropriately selecting a material.

In addition, in the case of water cooling, cavitation and boiling may occur in a region in which heat is concentrated, whereas liquid metal has a very high boiling point, so there is no such problem. The characteristic of low vapor pressure in an applied temperature range acts as an advantage of stably maintaining pressure in a pipe according to a temperature change. This means the ease of maintenance, such as corrosion and deformation of a channel portion and sealing.

In addition, since a refrigerant is allowed to flow by forming an induced current through magnetic force without using a mechanical device, pressure wave in a pipe through which the refrigerant flows may be minimized, and accordingly, the amplification medium may stably maintain the output performance.

In addition, a constant temperature of the amplification medium may be maintained by supplementing the shortcomings of the water-cooled cooling method and the oil-cooled cooling method.

The effects according to the present disclosure are not limited by the contents exemplified above, and more various effects are included in the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view illustrating a cooling module according to an embodiment of the present disclosure.

FIG. 2 is a perspective view illustrating a flow path of a refrigerant according to an embodiment of the present disclosure.

FIG. 3 is a cross-sectional view taken along line III-Ill of FIG. 1.

FIG. 4 is a perspective view illustrating a laser amplification medium cooling device according to an embodiment of the present disclosure.

FIG. 5 is an exploded perspective view illustrating a laser amplification medium cooling device according to an embodiment of the present disclosure.

FIG. 6 is a perspective view illustrating a first block according to an embodiment of the present disclosure.

FIG. 7 is a perspective view illustrating a second block according to an embodiment of the present disclosure.

FIG. 8 is an enlarged plan view of a portion of a second block according to an embodiment of the present disclosure.

FIG. 9 is a perspective view illustrating a third block according to an embodiment of the present disclosure.

FIG. 10 is a perspective view illustrating a bottom surface of a third block according to an embodiment of the present disclosure.

FIG. 11 is a perspective view illustrating a heat dissipation block according to an embodiment of the present disclosure.

### DETAILED DESCRIPTION

Hereinafter, embodiments will be described in detail with reference to the accompanying drawings. However, since various changes may be made to the embodiments, the scope of the present disclosure is not limited by these embodiments. It should be understood that all modifications, equivalents, and substitutes for the embodiments are included in the scope of coverage.

Specific structural or functional descriptions of the embodiments are disclosed for purposes of illustration only and may be changed and implemented in various forms. Accordingly, the embodiments are not limited to a specific disclosure form, and the scope of the present disclosure includes changes, equivalents, or substitutes included in the technical spirit.

Each feature of the various embodiments of the present disclosure may be partially or entirely combined with each other, and as those skilled in the art will fully understand, various interworking and driving may be performed technically, and each embodiment may be independently implemented with respect to each other or may be implemented together in a related relationship.

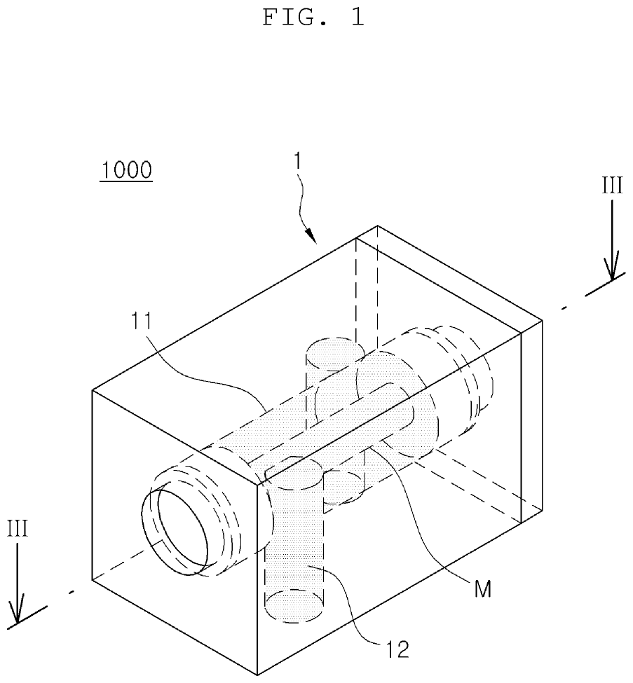

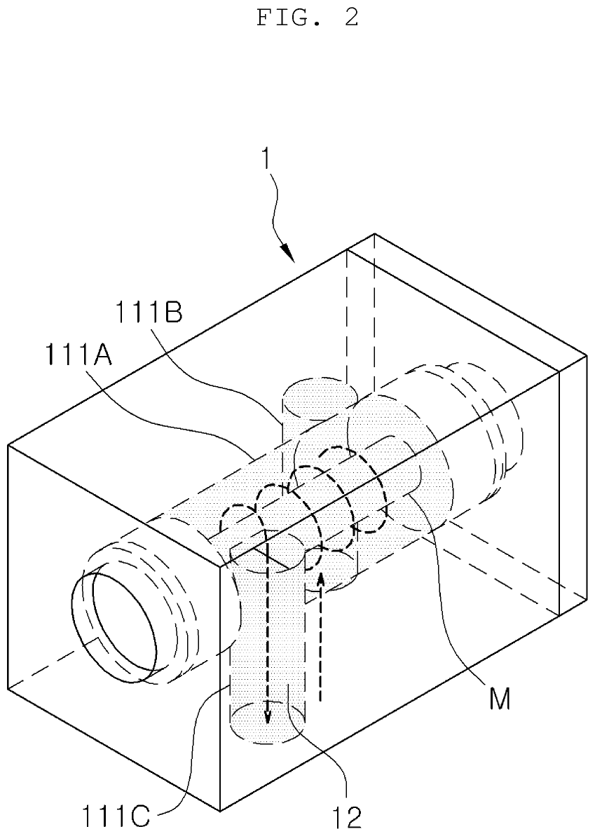

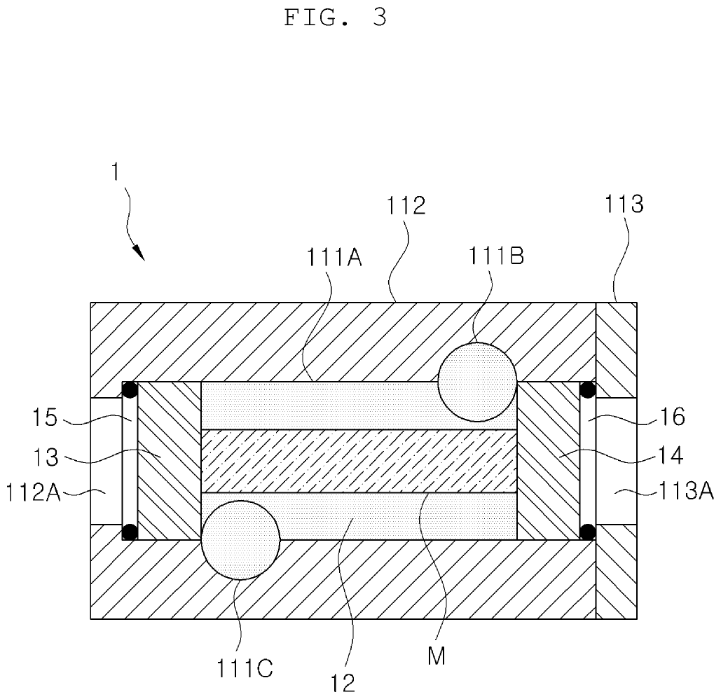

FIG. 1 is a perspective view illustrating a cooling module according to an embodiment of the present disclosure, FIG. 2 is a perspective view illustrating a flow path of a refrigerant according to an embodiment of the present disclosure, and FIG. 3 is a cross-sectional view taken along line III-Ill of FIG. 1.

Referring to FIGS. 1 to 3, a laser amplification medium cooling device 1000 according to an embodiment of the present disclosure (hereinafter, referred to as a ‘laser amplification medium cooling device 1000’) includes a cooling module 1.

The cooling module 1 is configured to cool an amplification medium M for amplifying a laser.

Here, the amplification medium M has a predetermined length and may be a cylindrical or rod-shaped crystal parallel to the laser.

The cooling module 1 includes a cooling chamber 11 and a refrigerant 12.

The cooling chamber 11 includes a flow path 111 in which the amplification medium M is accommodated.

The flow path 111 may be formed in the cooling chamber 11 so that the refrigerant 12 introduced therein flows in a spiral direction around the amplification medium M.

The flow path 111 may include a first flow path 111A, a second flow path 111B, and a third flow path 111C.

The first flow path 111A may be formed in a cylindrical structure so that the amplification medium M is accommodated therein and the refrigerant 12 introduced therein flows in a spiral direction along a circumference of the amplification medium M, but is not limited thereto and may have a structure allowing the refrigerant to flow in a straight direction.

The second flow path 111B may communicate with a portion of the first flow path 111A, may be disposed to intersect a central axis of the first flow path 111A, and may allow the refrigerant 12 to be introduced into the first flow path 111A.

The third flow path 111C may communicate with another portion of the first flow path 111A, may be disposed to cross a central axis of the first flow path 111A, and may allow the refrigerant 12 to be discharged from the first flow path 111A.

The cooling chamber 11 may further include a chamber housing 112 and a chamber cover 113.

The chamber housing 112 may have a flow path 111 formed therein, may have one side open in an axial direction and the other side provided with a first chamber hole 112A configured to communicate with the first flow path 111A, and the first chamber hole 112A may have a smaller diameter than that of the first flow path 111A.

The chamber cover 113 is coupled to an open side of the chamber housing 112 and may have a second chamber hole 113A communicating with the first flow path 111A and having the same diameter as that of the first chamber hole 112A.

The refrigerant 12 cools the amplification medium M while flowing along the flow path 111.

The refrigerant 12 is a metallic fluid that maintains a liquid state at room temperature.

The refrigerant 12 is formed of a material having a higher thermal conductivity coefficient than that of water or oil and a lower viscosity coefficient than that of oil.

The refrigerant 12 may include at least one of gallium (Ga), aluminum (Al), copper (Cu), bismuth (Bi), tin (Sn), and indium (In).

The cooling module 1 may further include a first window 13, a second window 14, a first hermetic ring 15 and a second hermetic ring 16.

The first window 13 may be accommodated in the first flow path 111A, may contact one end portion of the amplification medium M in the axial direction of the amplification medium M, and may be exposed to the outside through the first chamber hole 112A.

The second window 14 may be accommodated in the first flow path 111A, may contact the other end portion of the amplification medium M in the axial direction of the amplification medium M, and may be exposed to the outside through the second chamber hole 113A.

The first hermetic ring 15 may be accommodated in the first flow path 111A and may be press-fitted between the first window 13 and the first chamber hole 112A to seal a space between the first window 13 and the first chamber hole 112A.

The second hermetic ring 16 may be accommodated in the first flow path 111A and may be press-fitted between the second window 14 and the second chamber hole 113A to seal a space between the second window 14 and the second chamber hole 113A.

For example, the first window 13 and the second window 14 may be applied as plate-shaped optical glass, lens, etc. to which AR coating is applied, and may be in contact with or bonded to the amplification medium M to maintain their positions. Also, the first hermetic ring 15 and the second hermetic ring 16 are formed of an elastic material, and may be formed to have an ‘O’ shape.

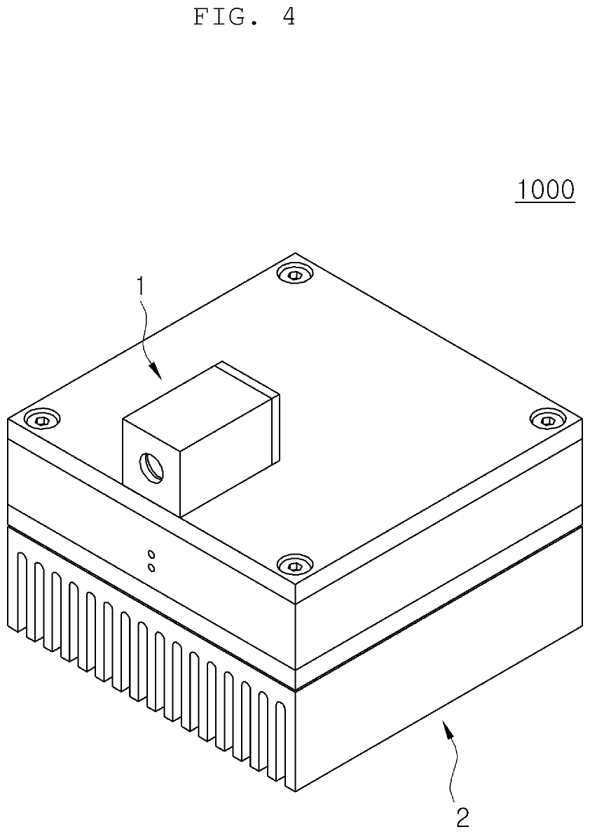

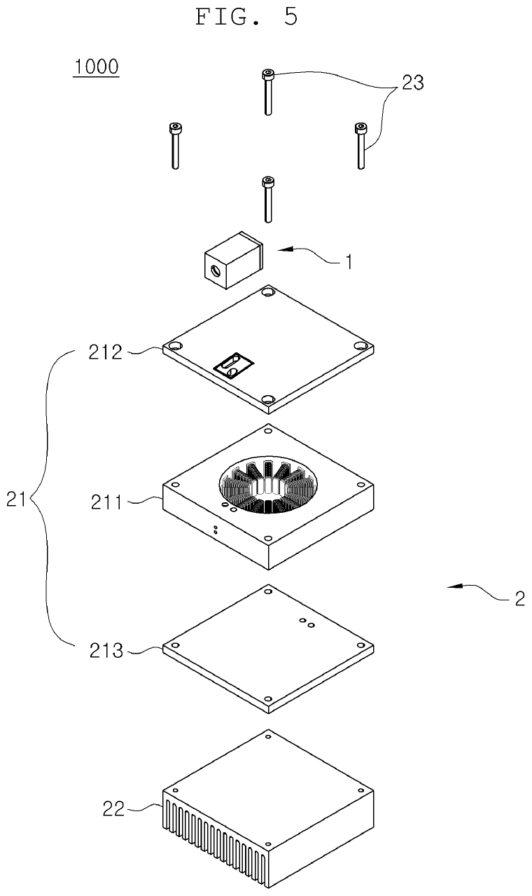

FIG. 4 is a perspective view illustrating a laser amplification medium cooling device according to an embodiment of the present disclosure, and FIG. 5 is an exploded perspective view illustrating a laser amplifying medium cooling device according to an embodiment of the present disclosure.

Referring to FIGS. 4 and 5, the laser amplification medium cooling device 1000 may further include a heat dissipation module 2.

The heat dissipation module 2 may be coupled to the cooling module 1 and may be configured to cool the refrigerant 12, while circulating the refrigerant 12.

The heat dissipation module 2 may include a circulation block assembly 21, a heat dissipation block 22, and a plurality of fastening members 23.

The circulation block assembly 21 may be coupled to the cooling module 1 and communicate with the cooling module 1, and circulate the refrigerant 12 to introduce and discharge the refrigerant 12 into and from the cooling module 1.

The circulation block assembly 21 may include a first block 211, a second block 212, and a third block 213.

The first block 211 may be configured to cause the refrigerant 12 accommodated therein to flow using a spatially changing magnetic force. Here, the spatial change of magnetic force may be implemented by a spatial movement of magnetic force using a physically moving permanent magnet, or may be implemented so that magnetic force is spatially moved by controlling currents of a plurality of electromagnetic windings 211C.

As described above, the principle of allowing a liquid metallic fluid to flow at room temperature by using the spatial change of the magnetic field is as follows.

When a magnetic field is changed, such as moving a strong magnet near a conductive material, such as a copper plate, a force that resists the movement of the magnet works by an induced current generated by the change of the magnetic field. As a reaction of resistance, a force in the same direction as that of the spatial change of the magnetic field acts on the conductive material, and it is possible to move the conductive material spatially by using the force.

If a conductor is a liquid metallic fluid, a pump that may move the metallic fluid in a desired direction may be configured. Here, a channel through which the metallic fluid flows may be configured to have an arc shape and the pump may be configured to rotate the magnetic field along the arc, or a channel may be configured to have a straight line shape and a pump may be configured to have a straight line shape so that a magnetic field changes in a direction parallel to the channel.

In addition, a pump may be configured so that a magnetic field acts to correspond to each of an inlet channel and an outlet channel connected to an inlet and an outlet of a specific component when a metallic fluid circulates through a plurality of components along the channel, but it is also possible to configure the pump so that the magnetic field acts on only one of the inlet channel and the outlet channel.

In each of the pump configurations described above, for a spatial change of the magnetic field, a physically moving permanent magnet or the electronically controlled electromagnetic winding 211C may be used as described above.

As a method different from the principle of operation of the pump described above, a pump may be configured using a principle of creating a flow of a metallic fluid in a channel direction when a spatial change is caused by applying a current to the liquid metallic fluid in the channel in a first direction perpendicular to the channel direction and applying a magnetic field in a direction perpendicular to both the first direction and the channel direction.

Hereinafter, for convenience of explanation, for the pump unit 211B for causing the refrigerant 12, which is a metallic fluid, to flow, a configuration in which magnetic force is rotated in a circular arc using the electromagnetic winding 211C will be described as an example. However, the configuration of the pump unit 211B is not limited thereto and may be modified in various forms described above.

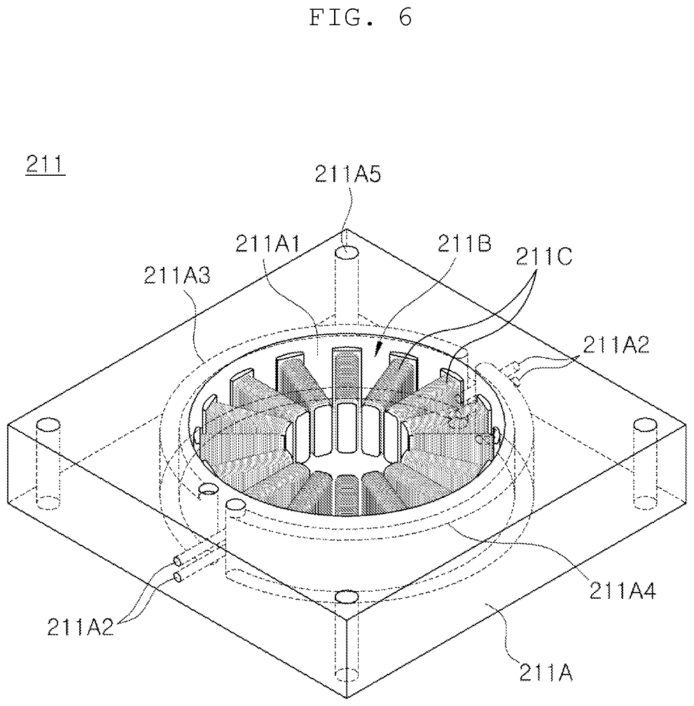

FIG. 6 is a perspective view illustrating a first block according to an embodiment of the present disclosure.

Referring to FIGS. 5 and 6, a first block 211 may include a block body 211A and a pump unit 211B.

The block body 211A may be disposed between a second block 212 and a third block 213 and may communicate with the second block 212 and the third block 213 so that the refrigerant 12 flows therein.

The block body 211A may include an accommodating hole 211A1 formed to penetrate through the center of the block body 211A and accommodating the pump unit 211B and a wiring hole 211A2 penetrating through the block body 211A to connect the accommodating hole 211A1 and an external space to form a wiring of the pump unit 211B.

Also, the block body 211A may include a first buffer channel 211A3 and a second buffer channel 211A4.

The first buffer channel 211A3 may be formed to have an arcuate shape and disposed inside the block body 211A to surround a portion of the accommodating hole 211A1.

A portion of the first buffer channel 211A3 may extend to an upper portion of the block body 211A to communicate with the second flow path 111B through the second block 212, and another portion of the first buffer channel 211A3 may extend to a lower portion of the block body 211A to communicate with the third block 213.

Accordingly, the refrigerant 12 heat-exchanged in the third block 213 may be introduced into the second flow path 111B through the first buffer channel 211A3.

The second buffer channel 211A4 may be formed to have an arcuate shape opposite to the first buffer channel 211A3 and disposed inside the block body 211A to surround another portion of the accommodating hole 211A1.

A portion of the second buffer channel 211A4 may extend to an upper portion of the block body 211A to communicate with the third flow path 111C through the second block 212, and another portion of the second buffer channel 211A4 may extend to a lower portion of the block body 211A to communicate with the third block 213.

Accordingly, the refrigerant 12 heat-exchanged with the amplification medium M in the cooling module 1 may be introduced into the third block 213 through the second buffer channel 211A4.

In addition, the block body 211A may further include a plurality of first through-holes 211A5 through which the plurality of fastening members 23 pass.

In the pump unit 211B, a plurality of electromagnetic windings 211C radially arranged so that a distal end forms an arc is accommodated in the accommodating hole 211A1 and disposed in the center of the block body 211A and forms magnetism by an induced current flowing in the electromagnetic winding 211C to cause the refrigerant 12 accommodated in the block body 211A to flow.

For example, the pump unit 211B may be configured to include a plurality of electromagnets with the electromagnetic windings 211C arranged to match the phase and forms an induced current so that magnetic force rotates without movement of the pump unit 211B to cause the refrigerant 12 to flow or may form an induced current, while moving or rotating a permanent magnet by a motor, to cause the refrigerant 12 to flow.

At this time, in the electromagnetic winding 211C, a magnitude or phase of the current flowing in the plurality of adjacent electromagnetic windings 211C may be controlled, so that a current flowing to cause the spatial change of the magnetic field to be made continuously rather than discontinuously may be controlled.

Referring to FIGS. 4 and 5, the second block 212 may be disposed between the cooling module 1 and the first block 211 and connect the cooling module 1 and the first block 211 to circulate the refrigerant 12.

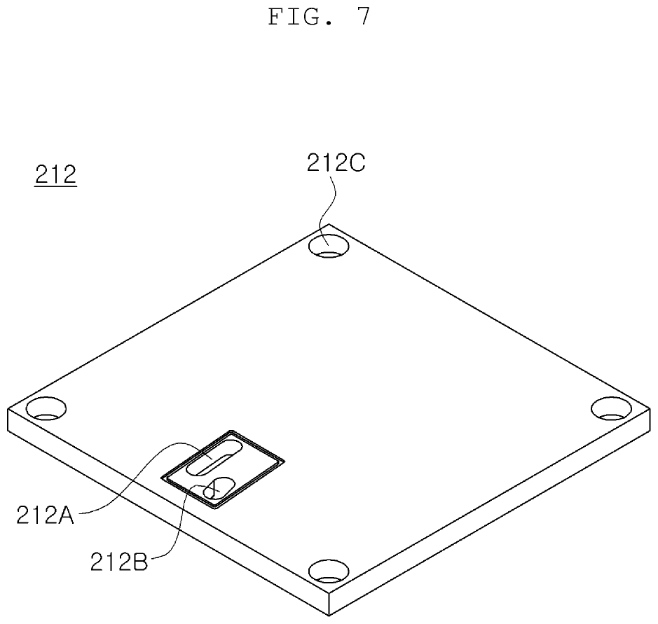

FIG. 7 is a perspective view illustrating a second block according to an embodiment of the present disclosure.

Referring to FIGS. 5 and 7, the second block 212 may include a first communication hole 212A connecting the first buffer channel 211A3 and the second flow path 111B and a second communication hole 212B connecting the second buffer channel 211A4 and the third flow path 111C.

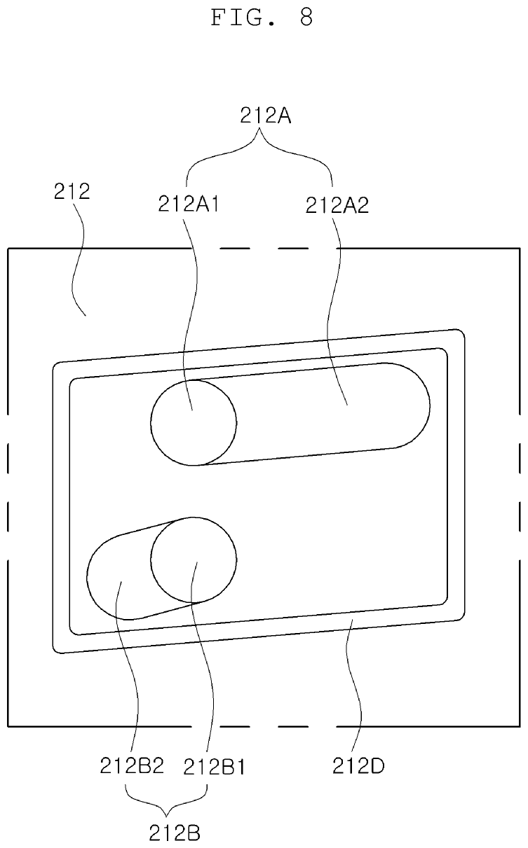

FIG. 8 is an enlarged plan view of a portion of a second block according to an embodiment of the present disclosure.

Referring to FIGS. 2, 6, and 8, the first communication hole 212A may include a first communication portion 212A1 and a first direction changing portion 212A2.

The first communication portion 212A1 may communicate with a portion of the first buffer channel 211A3 and may be disposed coaxially with a portion of the first buffer channel 211A3.

The first direction changing portion 212A2 may connect the first communication portion 212A1 and the second flow path 111B and change a flow direction of the refrigerant 12 flowing from the first communication portion 212A1 to the second flow path 111B to attenuate pressure wave of the refrigerant 12.

The second communication hole 212B may include a second communication portion 212B1 and a second direction changing portion 212E32.

The second communication portion 212B1 may communicate with a portion of the second buffer channel 211A4 and may be disposed coaxially with a portion of the second buffer channel 211A4.

The second direction changing portion 21262 may connect the second communication portion 212B1 and the third flow path 111C and change a flow direction of the refrigerant 12 flowing from the third flow path 111C to the second communication portion 212B1 to attenuate pressure wave of the refrigerant 12.

Referring to FIGS. 5 and 7, the second block 212 may further include a plurality of second through-holes 212C in communication with the plurality of first through-holes 211A5 and through which the plurality of fastening members 23 pass.

Referring to FIGS. 5, 7, and 8, the second block 212 may further include a first leak preventing groove 212D.

The first leak preventing groove 212D may be formed to have a loop shape and formed on one surface of the second block 212.

The first leak preventing groove 212D is closed by the cooling module 1 in contact with the second block 212, and may be disposed outside the first communication hole 212A and the second communication hole 212B on a plane of the second block 212.

Accordingly, the refrigerant 12 leaking between the cooling module 1 and the second block 212 may be prevented from being accommodated in the first leak preventing groove 212D and flowing out to the outside.

Referring to FIGS. 4 and 5, the third block 213 may be disposed between the first block 211 and the heat dissipation block 22 to communicate with the first block 211, and guide the refrigerant 12 so that the refrigerant 12 introduced from the first block 211 flows along the outer surface of the heat dissipation block 22 and then flows into the first block 211.

At this time, the refrigerant 12 guided by the third block 213 and flowing along the outer surface of the heat dissipation block 22 may be cooled through heat exchange with the heat dissipation block 22.

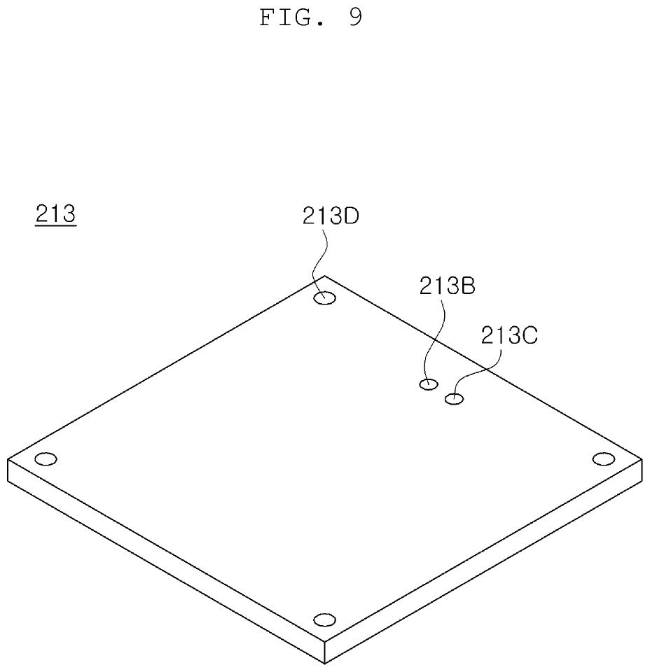

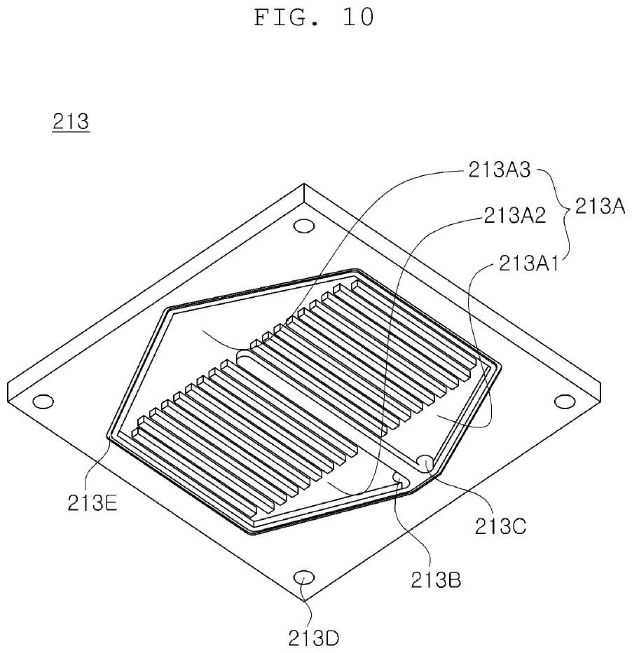

FIG. 9 is a perspective view illustrating a third block according to an embodiment of the present disclosure, and FIG. 10 is a perspective view illustrating a bottom surface of the third block according to an embodiment of the present disclosure.

Referring to FIGS. 5, 6, 9, and 10, the third block 213 may include a third buffer channel 213A, an outlet hole 213B, and an inlet hole 213C.

The third buffer channel 213A may be formed on one surface of the third block 213 in contact with the heat dissipation block 22, and may guide a flow of the refrigerant 12 so that the refrigerant 12 introduced through the second buffer channel 211A4 may be branched plurally to flow along the outer surface of the heat dissipation block 22.

The third buffer channel 213A may include a first channel portion 213A1, a second channel portion 213A2, and a third channel portion 213A3.

The first channel portion 213A1 may be configured so that the refrigerant 12 introduced through the inlet hole 213C is branched plurally to flow, while being diffused along the outer surface of the heat dissipation block 22.

For example, the first channel portion 213A1 may include a diffusion section in which the refrigerant 12 is gradually diffused to flow and a first branch section in which the diffused refrigerant 12 is branched plurally to flow.

The second channel portion 213A2 may be configured so that the refrigerant 12 that has passed through the first channel portion 213A1 is branched plurally to flow along the outer surface of the heat dissipation block 22 and is then integrated and discharged to the discharge hole 213B.

For example, the second channel portion 213A2 may include a second branch section in which the refrigerant 12 is branched plurally to flow, and an integration section in which the refrigerant 12 that has branched to flow is integrated to flow.

The third channel portion 213A3 connects the first channel portion 213A1 and the second channel portion 213A2, and the refrigerant 12 branched to flow from the first channel portion 213A1 is integrated to flow into the second channel portion 213A2.

The third channel portion 213A3 may have a reflective surface for changing a flow direction of the refrigerant 12.

The reflective surface may be configured to guide the refrigerant 12 flowing through the first channel portion 213A1 toward the second channel portion 213A2.

For example, the reflective surface may be formed to have a shape bent at a predetermined angle, such as ‘<’, or may be formed to have an arc shape, such as ‘)’.

The outlet hole 213B connects the third buffer channel 213A with another portion of the first buffer channel 211A3 so that the refrigerant 12 flowing in the third buffer channel 213A is discharged to the first buffer channel 211A3.

The inlet hole 213C connects the third buffer channel 213A and another portion of the second buffer channel 211A4 to allow the refrigerant 12 discharged from the second buffer channel 211A4 to flow into the third buffer channel 213A.

In addition, the third block 213 may further include a plurality of third through-holes 213D communicating with the plurality of first through-holes 211A5 through which the plurality of fastening members 23 pass.

Referring to FIGS. 5 and 10, the third block 213 may further include a second leak preventing groove 213E.

The second leak preventing groove 213E may be formed to have a loop shape and formed on one surface of the third block 213.

The second leak preventing groove 213E may be closed by the heat dissipation block 22 in contact with the third block 213, and may be disposed outside the third buffer channel 213A on the plane of the third block 213.

Accordingly, it is possible to prevent the refrigerant 12 flowing out between the heat dissipation block 22 and the third block 213 from being accommodated in the second leak preventing groove 213E and flowing out to the outside.

Meanwhile, although not shown in the drawings, the third block 213 may further include a conductive plate disposed between the third block 213 and the heat dissipation block 22.

The conductive plate contacts one surface of the third block 213 in which the third buffer channel 213A is formed, closes the third buffer channel 213A and the second leak preventing groove 213E, and guides the flow of the refrigerant 12 accommodated in the third buffer channel 213A.

In addition, the conductive plate may be in contact with the heat dissipation block 22 to conduct heat of the refrigerant 12 to the heat dissipation block 22.

For example, the conductive plate may be formed of a metallic material and have a thickness smaller than a height of the third buffer channel 213A.

Referring to FIGS. 4 and 5, the heat dissipation block 22 may be in contact with the circulation block assembly 21 and configured to heat-exchange the circulation block assembly 21 with the flowing refrigerant 12 to discharge heat of the refrigerant 12 to the outside.

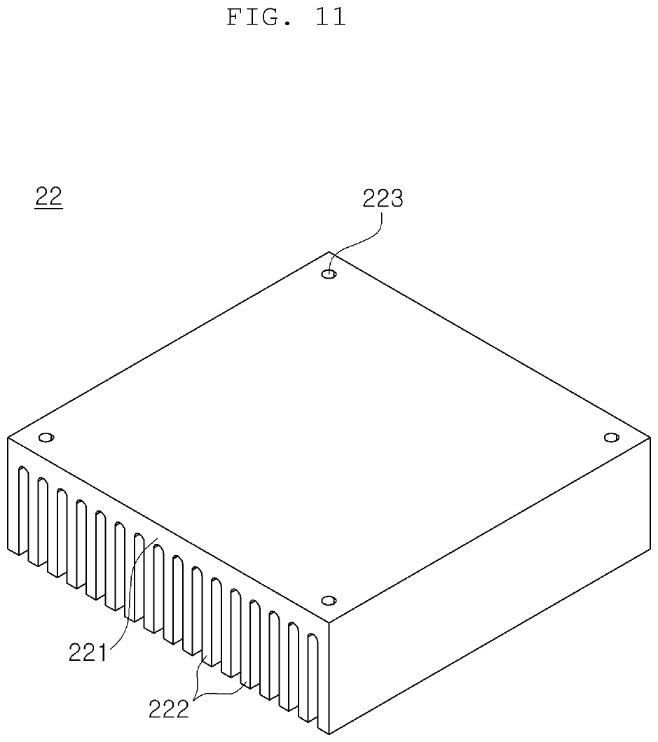

FIG. 11 is a perspective view illustrating a heat dissipation block according to an embodiment of the present disclosure.

Referring to FIGS. 5, 10, and 11, the heat dissipation block 22 may include a plate portion 221 in contact with the third block 213 to exchange heat with the refrigerant 12 flowing in the third buffer channel 213A and a plurality of heat dissipation fin portions 222 disposed along one surface of the plate portion 221 and dissipating heat conducted through the plate portion 221 to the outside.

For example, the plate portion 221 and the plurality of heat dissipation fin portions 222 may be formed of an aluminum material.

In addition, the heat dissipation block 22 may further include a plurality of fastening holes 223 formed in the plate portion 221 to communicate with the plurality of third through-holes 213D and screw-coupled to the plurality of fastening members 23 protruding to the outside through the plurality of third through-holes 213D.

Referring to FIGS. 4 and 5, the plurality of fastening members 23 may couple the circulation block assembly 21 and the heat dissipation block 22.

That is, the plurality of fastening members 23, while being fastened to the heat dissipation block 22 through the circulation block assembly 21, may press the circulation block assembly 21 toward the heat dissipation block 22 to be fixed.

For example, the plurality of fastening members 23 may be bolts having a predetermined length.

As such, according to the embodiment of the present disclosure, since a metallic fluid in a liquid state having a higher thermal conductivity than water or oil is used as the refrigerant 12, heat dissipation performance may be maximized and heat generated from the amplification medium M may be rapidly removed, and accordingly, damage to the amplification medium M due to heat may be prevented, thereby maintaining stable laser output performance.

In addition, since the refrigerant 12 is formed of a material having a lower viscosity coefficient than oil, the same flow may be maintained with less pump pressure compared to oil, and accordingly, a phenomenon in which pressure in a specific area increases so that the refrigerant 12 is leaked to the outside may be prevented.

In addition, since the refrigerant 12 is formed of a metallic material in a liquid state, corrosion of a contact object or blockage of the flow path 111 due to oxidation may be prevented.

In addition, the refrigerant 12 is configured to be sealed in the flow path or channel formed in each of the cooling module 1 and the first to third blocks 211, 212, and 213 through which the refrigerant 12 circulates, and in particular, the refrigerant 12 may be physically separately circulated, without contacting the pump unit 211B causing a flow of the refrigerant 12. Accordingly, it is possible to prevent contamination or failure of the pump unit 211B due to contamination of the refrigerant 12 from the outside or contact with the refrigerant 12.

In addition, since it is configured to cause the refrigerant 12 to flow by forming an induced current through magnetic force without using a mechanical device, pressure wave in the pipe through which the refrigerant 12 flows may be minimized, and accordingly, stable output performance of the amplification medium (M) may be maintained.

Although the embodiments of the present disclosure have been described in more detail with reference to the accompanying drawings, the present disclosure is not necessarily limited to these embodiments, and various modifications may be made within the scope without departing from the technical spirit of the present disclosure. Therefore, the embodiments disclosed in the present disclosure are not intended to limit the technical spirit of the present disclosure, but to explain, and the scope of the technical spirit of the present disclosure is not limited by these embodiments. Therefore, it should be understood that the embodiments described above are illustrative in all respects and not restrictive. The protection scope of the present disclosure should be construed by the following claims, and all technical ideas within the equivalent range should be construed as being included in the scope of the present disclosure.

Therefore, other implementations, other embodiments, and equivalents to the claims are also within the scope of the following claims.

What is claimed is:

1. A laser amplification medium cooling device comprising:
a cooling module configured to cool an amplification medium for amplifying a laser,
wherein the cooling module includes:
a cooling chamber having a flow path accommodating the amplification medium formed therein; and
a refrigerant flowing along the flow path to cool the amplification medium,
wherein the refrigerant is a metallic fluid that maintains a liquid state at room temperature.

2. The laser amplification medium cooling device of claim 1, wherein
the refrigerant includes at least one of gallium (Ga), aluminum (Al), copper (Cu), bismuth (Bi), tin (Sn), and indium (In).

3. The laser amplification medium cooling device of claim 1, wherein
the flow path is configured so that the refrigerant flows in a spiral direction around the amplification medium.

4. The laser amplification medium cooling device of claim 3, wherein
the flow path includes:
a first flow path accommodating the amplification medium and having a cylindrical structure so that the refrigerant introduced therein flows in a spiral direction along a circumference of the amplification medium;
a second flow path communicating with a portion of the first flow path, disposed to cross a central axis of the first flow path, and introducing the refrigerant into the first flow path; and
a third flow path communicating with another portion of the first flow path, disposed to cross the central axis of the first flow path, and discharging the refrigerant from the first flow path.

5. The laser amplification medium cooling device of claim 4, wherein
the cooling chamber includes:
a chamber housing having the flow path formed therein and having one side open in an axial direction and the other side provided with a first chamber hole communicating with the first flow path; and
a chamber cover coupled to the open one side of the chamber housing and having a second chamber hole communicating with the first flow path therein.

6. The laser amplification medium cooling device of claim 1, further comprising:
a heat dissipation module coupled to the cooling module and configured to cool the refrigerant, while circulating the refrigerant.

7. The laser amplification medium cooling device of claim 6, wherein
the heat dissipation module includes:
a circulation block assembly coupled to the cooling module, communicating with the cooling module, and configured to circulate the refrigerant to introduce and discharge the refrigerant to and from the cooling module using a spatial change in magnetic force; and
a heat dissipation block contacting the circulation block assembly and configured to heat-exchange with the refrigerant flowing in the circulation block assembly to dissipate heat of the refrigerant to the outside.

8. The laser amplification medium cooling device of claim 7, wherein
the circulation block assembly includes a first block configured to cause the refrigerant accommodated therein to flow using magnetic force,
wherein the first block includes:
a block body communicating with the cooling chamber and configured to allow the refrigerant to flow therein; and
a pump unit configured to cause the refrigerant accommodated in the block body to flow by a spatial change of magnetic force.

9. The laser amplification medium cooling device of claim 8, wherein
the pump unit is disposed in the center of the block body and configured to cause the refrigerant accommodated in the block body to flow by rotation of magnetic force.

10. The laser amplification medium cooling device of claim 9, wherein
the flow path includes:
a first flow path accommodating the amplification medium and having a cylindrical structure so that the refrigerant introduced therein flows in a spiral direction along a circumference of the amplification medium;
a second flow path communicating with a portion of the first flow path, disposed to cross a central axis of the first flow path, and introducing the refrigerant into the first flow path; and
a third flow path communicating with another portion of the first flow path, disposed to cross the central axis of the first flow path, and discharging the refrigerant from the first flow path, and
the block body includes:
an accommodating hole in which the pump unit is accommodated;
a wiring hole connecting the accommodating hole and an external space to form wiring of the pump unit;
a first buffer channel disposed inside the block body to surround a portion of the accommodating hole and having a portion extending to an upper portion of the block body to communicate with the second flow path; and
a second buffer channel disposed inside the block body to surround another portion of the accommodating hole and having a portion extending to an upper portion of the block body to communicate with the third flow path.

11. The laser amplification medium cooling device of claim 10, wherein
the circulation block assembly further includes:
a second block disposed between the cooling module and the first block and connecting the cooling module and the first block to allow the refrigerant to circulate,
wherein the second block includes:
a first communication hole connecting the first buffer channel and the second flow path; and
a second communication hole connecting the second buffer channel and the third flow path.

12. The laser amplification medium cooling device of claim 11, wherein
the first communication hole includes:
a first communication portion communicating with a portion of the first buffer channel and disposed coaxially with a portion of the first buffer channel; and
a first direction changing portion connecting the first communication portion and the second flow path and changing a flow direction of the refrigerant flowing from the first communication portion to the second flow path to attenuate pressure wave of the refrigerant, and
wherein
the second communication hole includes:
a second communication portion communicating with a portion of the second buffer channel and disposed coaxially with a portion of the second buffer channel; and
a second direction changing portion connecting the second communication portion and the third flow path and changing a flow direction of the refrigerant flowing from the third flow path to the second communication portion to attenuate pressure wave of the refrigerant.

13. The laser amplification medium cooling device of claim 10, wherein
the circulation block assembly includes:
a third block disposed between the first block and the heat dissipation block to communicate with the first block and guiding the refrigerant so that the refrigerant introduced from the first block flows along an outer surface of the heat dissipation block and then is introduced into the first block,
wherein the third block includes:
a third buffer channel formed on one surface of the third block in contact with the heat dissipation block and guiding a flow of the refrigerant so that the refrigerant introduced through the second buffer channel is branched plurally to flow along an outer surface of the heat dissipation block;
a discharge hole connecting the third buffer channel and another portion of the first buffer channel to discharge the refrigerant flowing from the third buffer channel to the first buffer channel; and
an inlet hole connecting the third buffer channel and another portion of the second buffer channel to introduce the refrigerant discharged from the second buffer channel into the third buffer channel.

14. The laser amplification medium cooling device of claim 13, wherein
the third buffer channel includes:
a first channel portion in which the refrigerant introduced through the inlet hole is branched plurally to flow, while being diffused along an outer surface of the heat dissipation block;
a second channel portion in which the refrigerant passing through the first channel portion is branched plurally to flow along the outer surface of the heat dissipation block and then integrated to be discharged to the outlet hole; and
a third channel portion connecting the first channel portion and the second channel portion, in which the refrigerant branched from the first channel portion to flow is integrated and introduced into the second channel portion.
